(19) United States
(12) Patent Application Publication
(10) Pub. No.: US 2010/0326292 A1
(43) Pub. Date: Dec. 30, 2010

(54) Crop Residue Baler Integrated with Harvester and Method for Baling Crop Residue

(76) Inventor: Ben N. Dillon, Logansport, IN (US)

Correspondence Address: MUELLER AND SMITH, LPA;MUELLER-SMITH BUILDING, 7700 RIVERS EDGE DRIVE, COLUMBUS, OH, 43235, US

(21) Appl. No.: 12/880,432

(22) Filed: Sep. 13, 2010

Related U.S. Application Data
(63) Continuation-in-part of application No. 12/707,981, filed on Feb. 18, 2010.
Application No. 12/707,981 is a continuation-in-part of application No. 12/550,451, filed on Aug. 31, 2009.
(60) Provisional application No. 61/219,806, filed on Jun. 24, 2009.

(51) Int. Cl. B65B 13/02; B60B 33/00

(52) U.S. Cl. 100/2; 16/45; 100/1

(57) ABSTRACT

A combine having an integral crop residue round baler includes an operator's cab, an engine, a grain harvesting assembly, a grain transfer assembly, a grain bin, and a grain off-loading assembly. The towed crop residue round baler is located at the rear of the combine and moves integrally therewith for forming a crop residue bale. The towed crop residue round baler can be connected to the combine by a pair of widely spaced apart joint assemblies that permit the towed crop residue round baler to move only in the pitch axis. A tractor assembly for baling crop material, is fitted with a quick hitch assembly for towing a towed crop residue round baler connected to the tractor by said quick hitch assembly configured such that only movement in the pitch axis is permitted and such that tractor carries a portion of weight of the towed rear unit.

### CROSS-REFERENCE TO RELATED APPLICATIONS

This application is a continuation-in-part of application Ser. No. 12/707,981, filed on Feb. 18, 2010, which is a continuation-in-part of application Ser. No. 12/550,451, filed on Aug. 31, 2009; and claims benefit of provisional application Ser. No. 61/219,806, filed on Jun. 24, 2009, the disclosures of which are expressly incorporated herein by reference.

### STATEMENT REGARDING FEDERALLY SPONSORED RESEARCH

Not applicable.

### BACKGROUND

The present disclosure generally relates to grain harvesters (or combines) and farm tractors and more particularly to integrating a crop residue baler with these farm vehicles.

The growth and development of renewable bio fuels and associated processes has created interest and demand for new methods to collect biomass. One area of particular interest is the residue normally left in the field after harvesting grain crops, such as corn, for example. Collecting, storing, transporting, and preserving crop residue presents major problems. It usually is only available in the field once per year. It is not energy concentrated like the grain. It can rot or start to ferment if left unprotected in the weather. It also is almost impossible to transport, as it is currently ejected from a harvester, such as a combine, because it is of very low density.

Secondary processes or machines, such as cob collectors or balers towed by tractors, have been used to increase the density of crop residue and improve its transportability. In some cases, the cob collectors or balers have been towed behind the combine by a pivoting connection. This presents challenges to productivity and maneuverability.

Baling functions for the primary crop have been integrated into cotton pickers. They do not deal with crop residue, which is left in the field with these machines.

The ideal solution to increase crop residue density, transportability, and ability to tolerate weather, is to bale it in a unique shape as an integral part of the harvester with no other machines or processes needed. This requires the baling function of feeding, compressing, forming, and constraining the material to be integrated into the residue handling function of the harvester without interfering with its ability to harvest and transport the desired grain. This is difficult in the typical combine that is commercially available today, due to lack of space inside and on top, since the grain tank takes most of the space on top. They also are subject to weight limitations on both the main and steering axles. A baler can be combined with a conventional combine in a unique embodiment disclosed herein.

These constraints are not present in the articulated harvester disclosed in U.S. Pat. No. 6,012,272. The engine, cooling system, and machinery drives are mounted behind the operator's cab in space normally occupied by the clean grain tank. This arrangement provides space on top of the rear of the machine to mount baling components and insert the baling process into the residue stream. The steering axle weight limitation is not present, since all axles on an articulated machine are load bearing and there is no steering axle.

### BRIEF SUMMARY

In one embodiment, a combine having an integral crop residue round baler includes an operator's cab, an engine, a grain harvesting assembly, a grain transfer assembly, a grain bin, and a grain off-loading assembly. The towed crop residue round baler is located at the rear of the combine and moves integrally therewith for forming a crop residue bale. The towed crop residue round baler can be connected to the combine by a pair of widely spaced apart joint assemblies that permit the towed crop residue round baler to move only in the pitch axis.

In another embodiment, a tractor assembly for baling crop material, is fitted with a quick hitch assembly for towing a towed crop residue round baler connected to the tractor by said quick hitch assembly configured such that only movement in the pitch axis is permitted and such that tractor carries a portion of weight of the towed rear unit.

The crop residue baler in both embodiments (i.e., tractor and combine towing vehicle) can be a conventional towed round baler, provided that the connection to the towing vehicle is restricted to a joint that only permits movement in the “Z” or pitch axis.

For present purposes, “combine” and “harvester” are used interchangeably.

### BRIEF DESCRIPTION OF THE DRAWINGS

For a fuller understanding of the nature and advantages of the present apparatus and method, reference should be had to the following detailed description taken in connection with the accompanying drawings, in which:

FIG. 1 is a side elevational view of an articulated harvester towing the integral crop residue baler assembly disclosed herein;

FIG. 2 is an overhead view of the articulated harvester of FIG. 1;

FIG. 3 is an exploded side elevational view of the towed round baler showing a round bale being discharged; and

FIG. 4 is an overhead view of the towed crop residue baler of FIGS. 1 and 2 showing the joint interconnecting the towing vehicle and the towed baler where the joint only permits movement in the “Z” or pitch axis;

FIG. 5 is a sectional view taken along 5-5 of FIG. 4;

FIG. 6 is an overhead view of the towed crop residue baler of FIGS. 1 and 2 showing only the base structure;

FIG. 7 shows a towed crop baler for crop windrows like that illustrated in FIG. 13, but being towed by a farm tractor, where a modified tow bar and joint assembly are provided by virtue of the use of a tractor for towing;

FIG. 8 is a top view of the tractor towing version of FIG. 7;

FIG. 9 is a sectional view taken along line 9-9 of FIG. 15; and

FIG. 10 is another side elevational view of an articulated harvester towing the integral crop residue baler and processing only crop residue created by the harvester.

These drawings will be described in further detail below in connection with the detailed description of the disclosed combine and transverse crop residue baler disclosed herein.

### DETAILED DESCRIPTION

The subject of an articulated harvester, some of which are based on current commercial grain harvester designs, is disclosed in U.S. Pat. Nos. 4,317,326, 4,428,182, 6,012,272, 6,125,618, 6,339,917, 6,604,351, 6,606,844, 6,604,995, 6,604,350, 6,484,485, 6,612,101, 6,233,911, 6,240,711, and 6,167,982. A harvester/grain cart combination can be converted to an “articulated” combine as disclosed in U.S. Pat. No. 6,910,845. Various grain handling and grain unloading techniques are disclosed in U.S. Pat. Nos. 7,143,863 and 7,198,449.

A departure from the art is disclosed in U.S. Pat. No. 6,012,272, however, in that the forward bogey is devoid of an on-board grain bin, but carries the operator's cab, engine, grain harvesting assembly, and grain transfer assembly. The rear bogey has the on-board grain bin and steerable powered wheel assembly. U.S. Pat. No. 6,339,917 discloses a similar articulated combine where the forward bogey is devoid of an on-board grain bin, but carries the operator's cab, engine, grain harvesting assembly, and grain transfer assembly. The rear bogey has the on-board grain bin and a powered wheel assembly. Tracks, one wheel pair, and two wheel pairs, are illustrated for the harvester.

Finally, application Ser. No. 12/002,714, filed Dec. 18, 2007, discloses an improved harvester, which includes the rearward bogey having a powered wheel assembly of a powered stiff axle wheel assembly pivotable for steering the articulated harvester when the joint has articulated by a defined number of degrees. The joint may be connected to the rearward bogey powered stiff axle wheel assembly by a beam that has a second joint disposed ahead of the stiff axle and actuatable to crab the articulated harvester for grain unloading. The disclosures of these patents and application are expressly incorporated herein by reference.

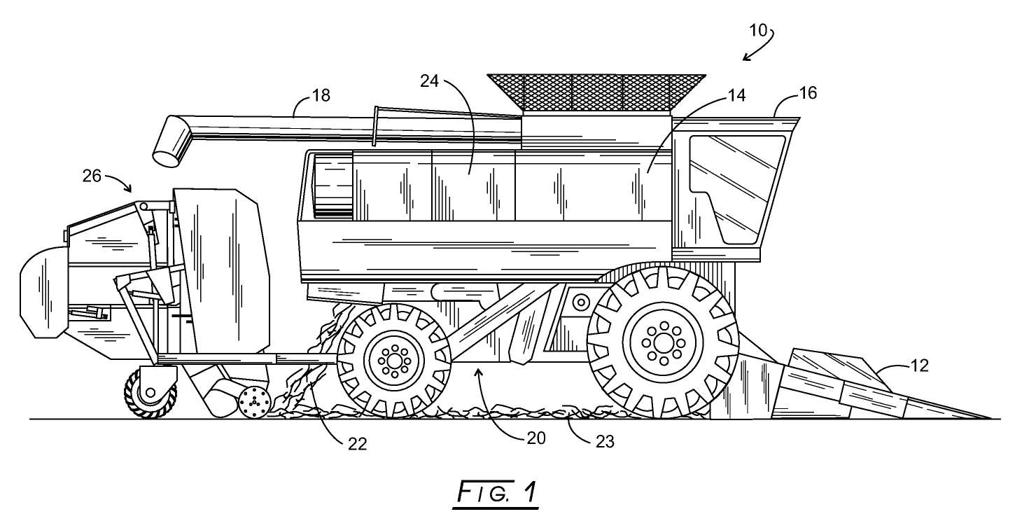

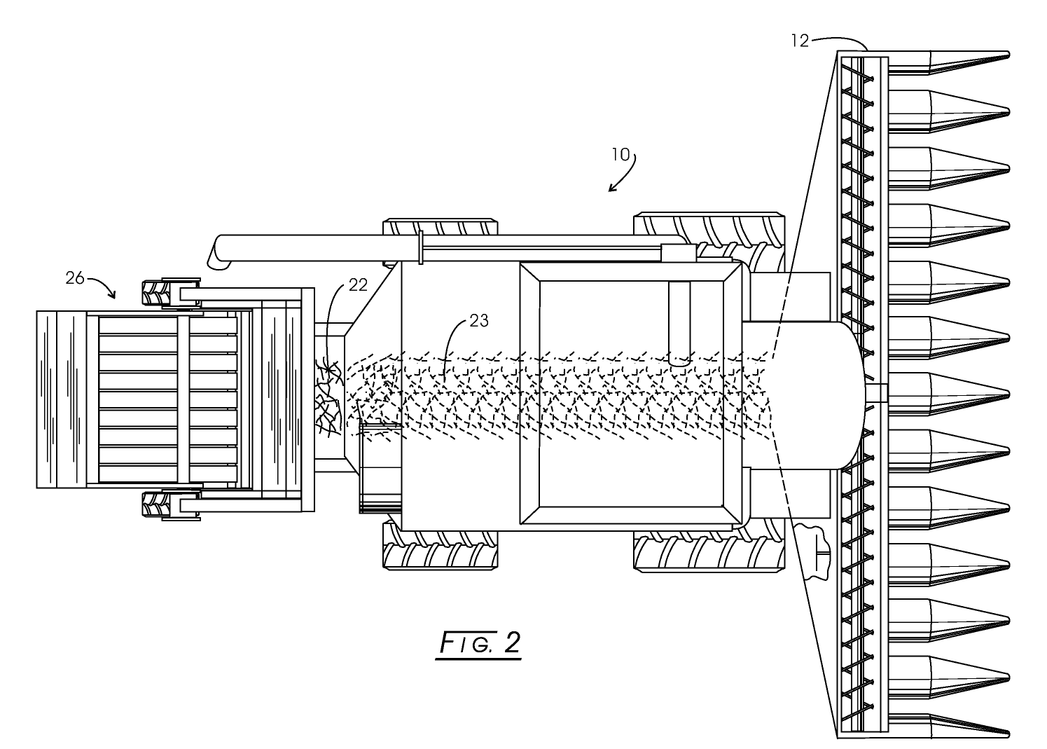

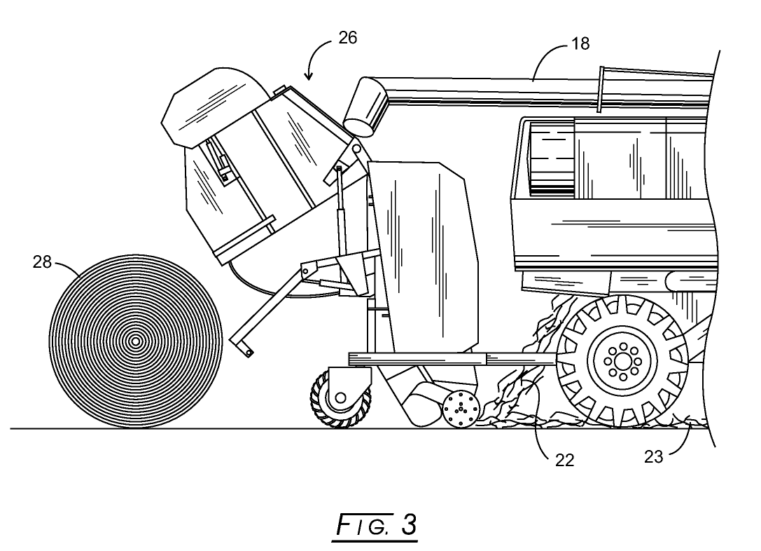

The general design, layout, and operation of an articulated combine can be found in the immediately cited patents. Only a cursory description, then, will be set forth below in order to understand the crop residue baler disclosed herein. Referring initially to FIGS. 1-3, a combine, 10, includes a 12-row, 30-foot cornhead, 12, an engine, 14, and an operator's cab, 16, a grain unloading assembly, 18, grain cleaning assembly, 20, and onboard grain bin, 24. Combine 10 tows a round baler, 26. Round bale discharge sequence can be seen in FIG. 3, where a round crop residue baler, 28, is being discharged from round baler 26. A crop reside, 22, created by combine 10, can be picked up by baler 26 for forming round crop residue bales (like bale 28 of FIG. 3) or baler 26 can pick up a row of crop reside, 23, that was previously created. Alternatively, round baler 26 can be fitted with a chute, 21, for catching and processing only crop residue stream 22 created by harvester 10, as illustrated in FIG. 10.

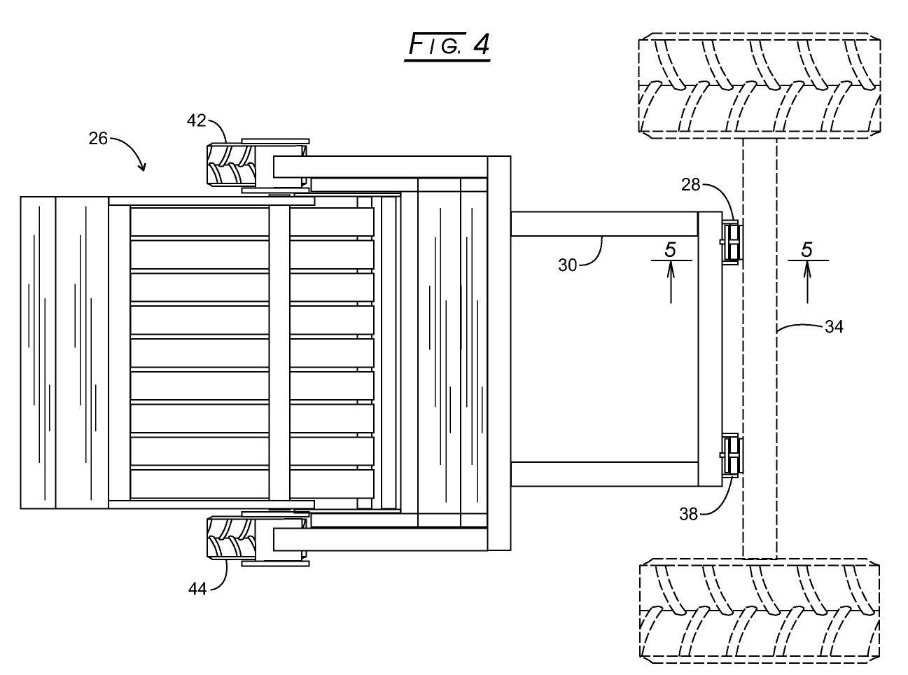

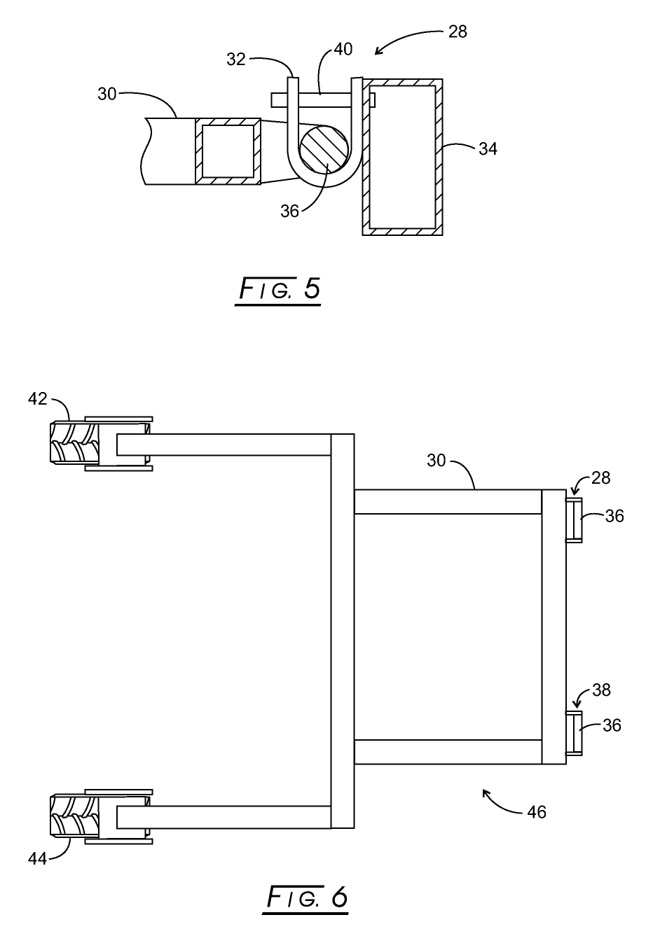

Referring now additionally to FIGS. 4-6, crop residue baler 26 rides on caster wheels, 42 and 44. From FIGS. 4 and 6, it will be observed that round crop residue baler 26 is attached to combine 10 at two widely spaced apart locations by joint assemblies, 28 and 38. Such widely spaced-apart joint assemblies means that towed crop residue baler 26 will follow combine 10 as if their combination was a single, integral unit. As will be described below, towed transverse crop residue baler 26 is only permitted to move in the pitch (Z) axis by the joint assemblies 28 and 38.

Towed transverse crop residue baler 26 operates just like crop residue baler is otherwise (than the joint assembly pairs) conventional in structure and operation. A variety of commercially available round balers have been on the market for several decades and currently can be purchased from Agco, Massey Ferguson, Hesston, New Holland, Case IH, John Deere, Krone, and other manufacturers. A wide variety of art is available describing various aspects of operation of and components for round balers. These patents include, inter alia, U.S. Pat. Nos. 5,388,504, 5,941,168, 6,447,824, 6,675,561, 7,337,713, and 7,716,903, just to mention a few of such patents.

A tow assembly, 46, includes a tow bar assembly, 30 and “U” shaped receiver, 32, mounted on axle 34 and configured to receive a round transverse bar, 36. Of course, the other joint assembly, 38, is the same as joint assembly 28, so its detailed description is omitted. Once round transverse tow bar 36 has been placed within receiver 32, a locking pin, 40, is inserted across the top of receiver 32 to secure baler 26 in its towed position. Such design of joint assembly 28, permits tow bar assembly 30 and, hence, baler 26, to move only in the pitch axis (up and down); otherwise, baler 26 will behave as if it is part of or integral with combine 10.

The rear of baler 26 is supported by dual caster wheel assemblies having caster wheels movable 360° in the field or use mode. Caster wheel assemblies 42 and 44 desirably are locking so that during transportation of baler 26 each caster wheel assembly only rotates in the forward direction and do not rotate. During field use of baler 26, however, 360° rotation of caster assemblies 42 and 44 permit baler 26 to turn integrally with combine 10. For example, baler 26, during a turn to the left, will have caster wheel assembly 44 turn faster than caster wheel assembly 42, because baler 26 cannot pivot or rotate about its connection to combine 10 due to the dual joint interconnection set forth herein. Jackknifing also is suppressed during backing up of combine 10/baler 26 by virtue of the two joint assembly connection of baler 26 to combine 10.

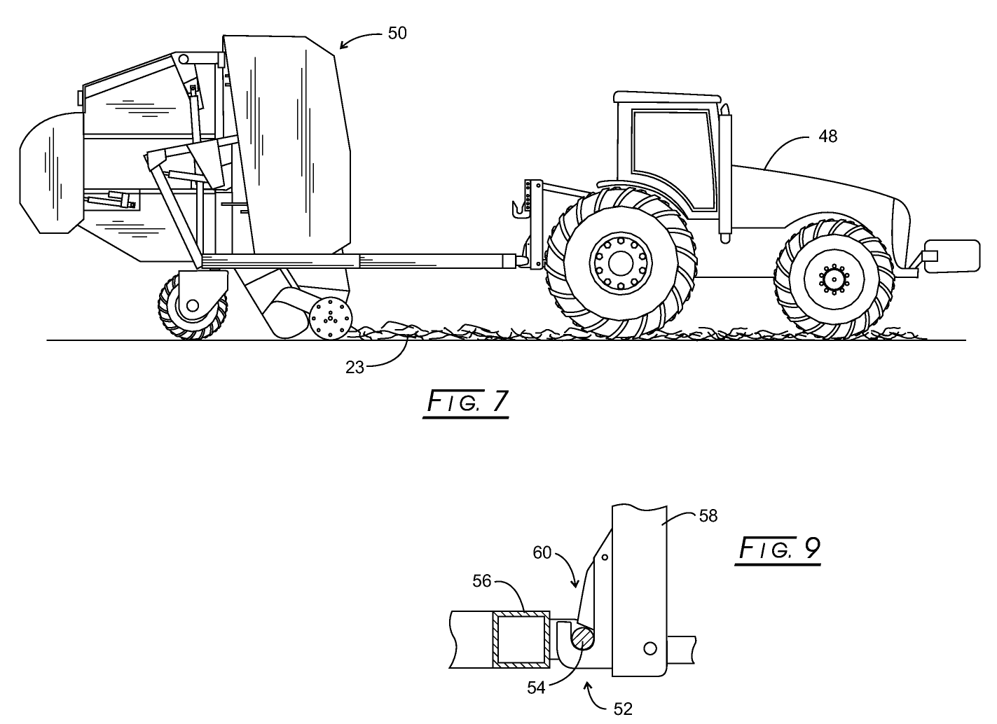

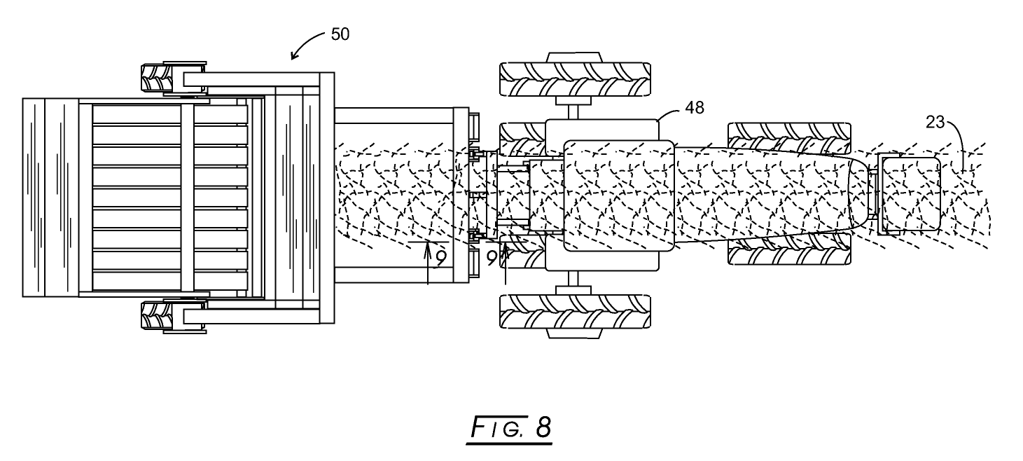

Yet another embodiment of the towed baler is illustrated in FIGS. 7-9. In this embodiment, however, a conventional farm tractor, 48, tows a baler, 50, that operates like baler 26, but for its connection to tractor 48.

Tractor 48 can be fitted with a conventional standard category 3 or 4 tractor quick hitch, with spacing of the two lower joints regulated by the hitch category. The upper, 3^{rd} point of the hitch remains unused. The same frame and joint assembly shown in FIGS. 5 and 6 can be used in this embodiment, except that the joint assemblies need to protrude less from the frame that in the combine embodiment. A logical question is why cannot the tow bar and joint assemblies be the same for a combine as for a tractor. In theory, they could be; however, the turning moment on the combine rear axle is reduced if the joint spacing (joints 28 and 38) is as far apart as possible. The spacing for a category 3 or 4 tractor quick hitch is determined by the ASAE standard for tractor three point quick hitches.

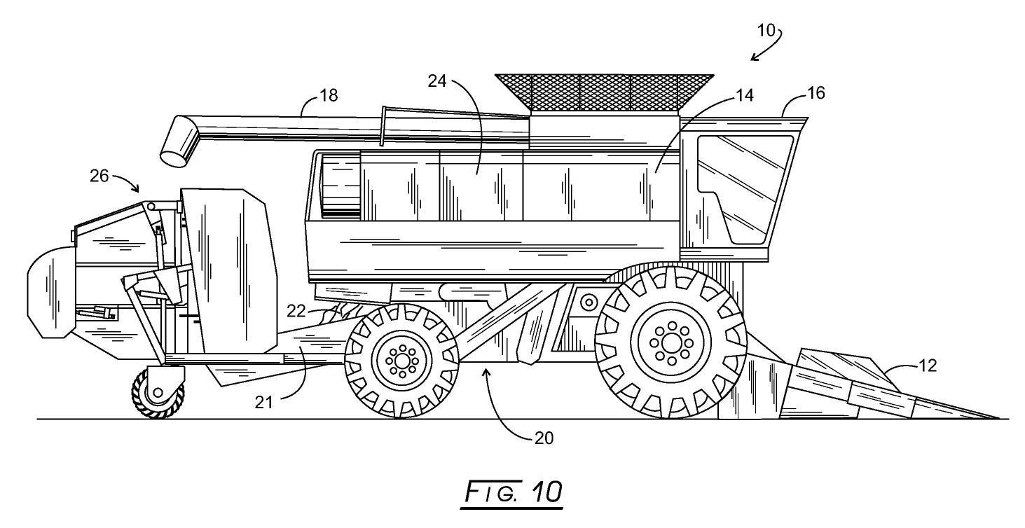

Referring now to FIG. 9, a joint assembly, 52, for the tractor embodiment is shown to be a simple round transverse bar, 54, carried by tow bar 56. Round transverse bar 54 in turn fits into a tractor hitch, 58, which includes a U-receiver with spring lock assembly, 60. The other joint assembly is the same as joint assembly 52 and will not be described in detail. The tow bar and joint design, however, is such that the tractor (or combine in the towed embodiment) carries a portion of weight of said towed rear baler.

While the apparatus and its operation has been described with reference to various embodiments, those skilled in the art will understand that various changes may be made and equivalents may be substituted for elements thereof without departing from the scope and essence of the disclosure. Additionally, many modifications may be made to adapt a particular situation or material to the teachings of the disclosure without departing from the essential scope thereof. Therefore, it is intended that the disclosure may not be limited to the particular embodiments disclosed, but that the disclosure will include all embodiments falling within the scope of the appended claims. In this application the US measurement system (foot, gallon, and pound) is used, unless otherwise expressly indicated. Also, all citations referred to herein are expressly incorporated herein by reference.

I claim:

1. A combine having an integral crop residue round baler, which comprises:
(a) an operator's cab, an engine, a grain harvesting assembly, a grain transfer assembly, a grain bin, and a grain off-loading assembly; and
(b) a towed crop residue round baler disposed at the rear of said combine and moving integrally therewith for forming a crop residue bale.

2. The method of claim 1, wherein said towed crop residue round baler is supported by a caster wheel assembly comprising a pair of spaced-apart caster wheels pivotally connected to said baler.

3. The method of claim 1, wherein said towed crop residue round baler is connected to said combine by a pair of widely spaced apart joint assemblies that permit said towed crop residue round baler to move only in the pitch axis.

4. A tractor assembly for baling crop material, which comprises:
(a) a tractor fitted with a quick hitch assembly for towing; and
(b) a towed crop residue round baler connected to said tractor by said quick hitch assembly configured such that only movement in the pitch axis is permitted and such that tractor carries a portion of weight of said towed rear unit.

5. The method of claim 4, wherein said towed crop residue round baler is supported by a caster wheel assembly comprising a pair of spaced-apart caster wheels pivotally connected to said baler.
